(19) United States
(12) Patent Application Publication
(10) Pub. No.: US 2003/0073474 A1
(43) Pub. Date: Apr. 17, 2003

(54) Trivia sports game

(76) Inventor: William Kenneth Bowman, Moon Twp., PA (US)

Correspondence Address: John Dodds, 1707 N St., NW, Washington, DC, 20036, US

(21) Appl. No.: 10/076,852

(22) Filed: Feb. 14, 2002

Related U.S. Application Data
(60) Provisional application No. 60/284,259, filed on Apr. 17, 2001.

(51) Int. Cl. G06F 17/00

(52) U.S. Cl. 463/9

(57) ABSTRACT

This game is based on a background that constitutes the “field” of play. While originally developed as a board game, other embodiments of the invention may be electronic as a computer or hand-held electronic version. The background is designed so as to represent a playing field with locations of yard lines, end zones, etc. Players select cards that ask trivia questions about the game in general, that may include history and factoids on the entire game of football, including players, teams, team owners, coaches, statistical result data, fans, etc. The cards may be sub-divided to represent particular events, such as “down cards,” “wild cards,” etc. The game is played for a finite time period, or a fixed-point winner basis. Moveable flags, and a football piece are included to place on the correct yard line.

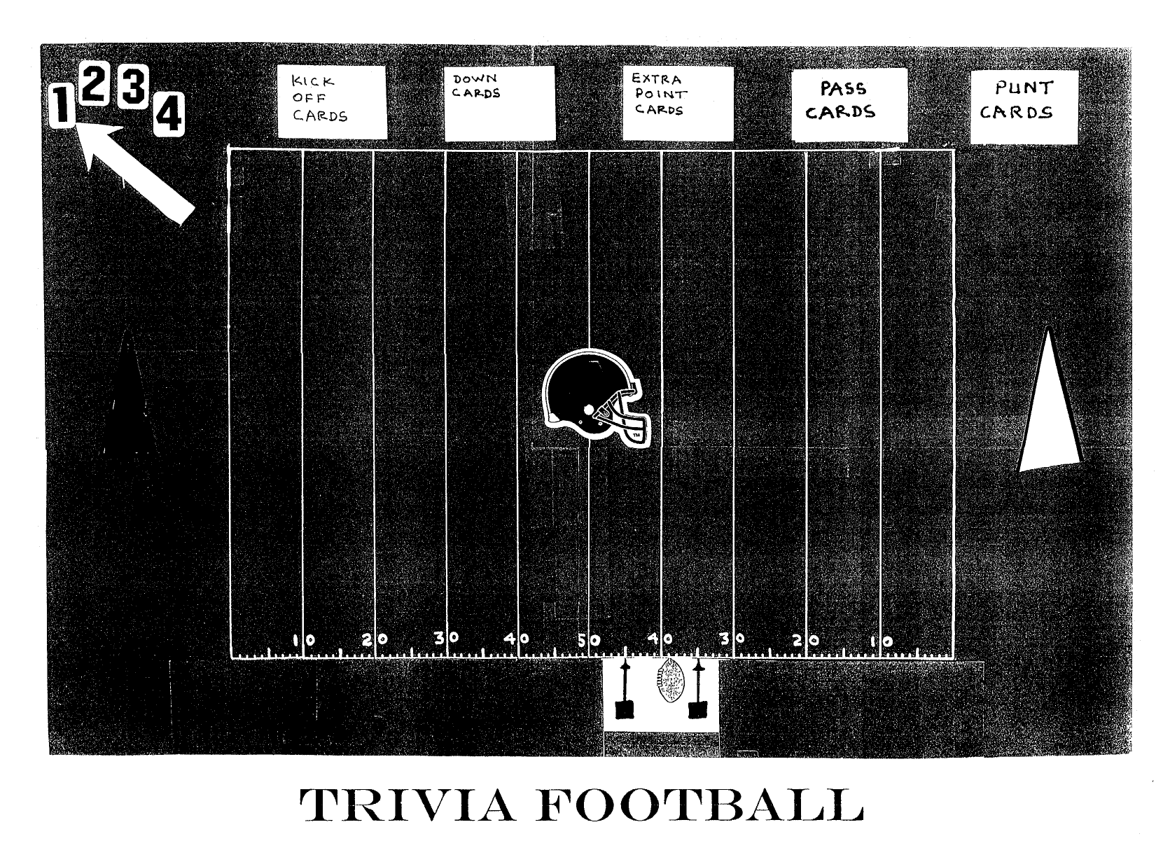

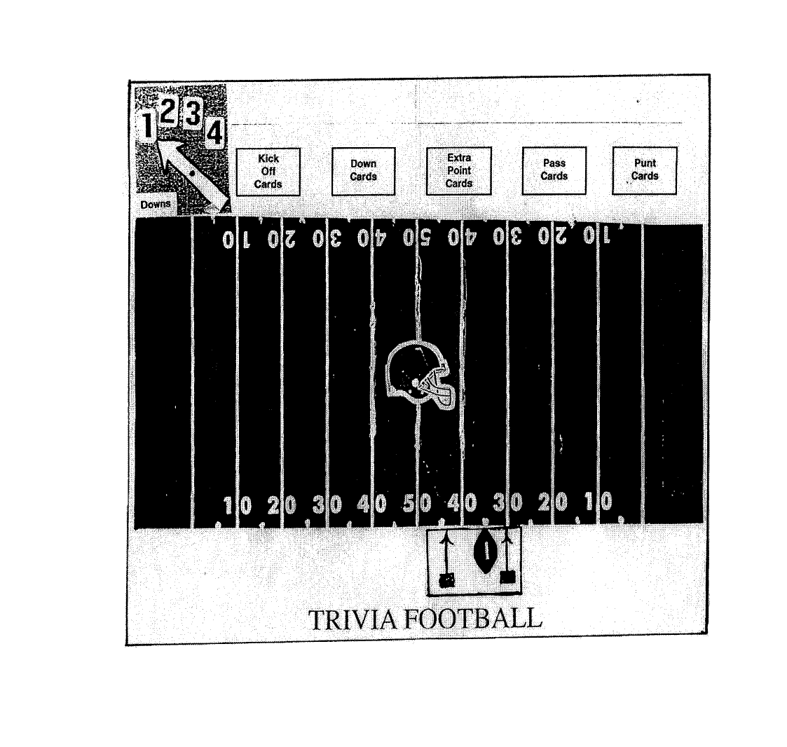

### BACKGROUND & CROSS REFERENCES TO RELATED APPLICATIONS

This application is entitled to benefit of Provisional Patent Application Serial No. 60/284,259 filed Apr. 17, 2001.

### FEDERALLY SPONSORED RESEARCH

Not applicable for this invention does not derive from Federally funded research.

### REFERENCE TO MICROFICHE APPLICATION

Not applicable to this application.

1. Field of Invention

This invention relates to trivia games, particularly in the subject of team sports.

2. Discussion of Prior Art

There are several sports board games present in the prior art that simulate sports such as football. For example we have Pat. No. 3,814,426 (Moe, 1974), which describes a football game simulated in a miniature football stadium. There are also board games that require or combine strategy, knowledge of sports and/or chance for winning the games. Some of them are played with dice, some with cards, some with sports equipment pieces. For example, U.S. Pat. No. 5,769,419 (Hill, 1998) describes a football board game involving the use of a ball marker, play cards, dice, and outcome chart, amongst other features. There are also sports board games that have question cards to test the knowledge of players, such as U.S. Pat. No. 5,123,653 (Murphy et al, 1992) for a basketball game board apparatus; U.S. Pat. No. 5,087,051 (LoBue, 1992) for a quiz football board game; U.S. Pat. No. 5,746,431 (McIntyre et al, 1998) for a question and answer football game; and U.S. Pat. No. 5,901,956 (Warmack, 1999) for a team sport board game.

Nevertheless, none of the aforementioned patents the exact same invention subject matter of the present application. This invention relates to a novel and useful trivia sports game that can have different embodiments, such as a board game, a computer game, a hand-held electronic version and finally a game played online by Internet pairing or team formation. Furthermore, for the different electric embodiments, a minimum of one player is required, differing in another aspect from the game boards and games existing in the prior art. Finally, the use of cards such as “wild cards” (amongst the others used in this game) is also novel. For all of these reasons, the present invention is new, useful and merits patent protection.

### SUMMARY

This game is based on a background that constitutes the “field” of play. While originally developed as a board game, other embodiments of the invention may be electronic such as a computer or hand-held electronic version. The background is designed so as to represent a sports playing field with locations of yard lines, end zones etc. Players shall select cards that ask trivia questions about the game in general, that may include history and factoids on the entire game of the relevant sport, including players, teams, team owners, coaches, statistical result data, fans, etc. The cards may be sub-divided to represent particular events, such as “down cards,” “wild cards,” etc. The game is played for a finite time period, or a fixed-point winner basis. Moveable flags, and a football or other sports equipment piece are included to place on the correct yard line.

### OBJECTS & ADVANTAGES

This invention offers a number of useful advantages over board game or electronic game devices. These include:

1. It is a game that can be enjoyed and won not only by the football expert, but by anyone or a team that has the luck of the draw with a particular wild card.

2. The game is easy to play and can be used by age groups 5 and over.

3. In the board game embodiment no batteries are needed, so it is portable and can be used at tailgate parties, etc.

4. It encourages family and social interaction.

5. It is educational as it enlightens the players on facts and history of the game.

6. It enables people that are unable to play sports for physical problems or lack of time to play an entertaining game that involves such sport and its world (teams, players, coaches, history, etc.)

### DESCRIPTION OF DRAWINGS

A color drawing of the invention is attached hereto.

### DESCRIPTION OF INVENTION

This game is based on a background that constitutes the “field” of play. While originally developed as a board game, other embodiments of the invention may be electronic such as a computer or hand-held electronic version. The background is designed so as to represent a playing field with locations of yard lines, end zones, etc. Players shall select cards that ask trivia questions about the game in general, that may include history and factoids on the entire game of football or another sport, including players, teams, team owners, coaches, statistical result data, fans, etc. The cards may be sub-divided to represent particular events, such as “down cards,” “wild cards,” “kick off,” “extra point,” “pass,” “punt,” etc. The game is played for a finite time period, or a fixed-point-winner basis. Moveable flags and a sports piece are included to place on the correct yard line.

The questions may be formulated in multiple-choice format, true or false categories or as simple question-and-answer. The questions may be either serious or frivolous/humorous in nature.

The wild cards may allow, but are not limited to:

Award of defense turnovers by interceptions and fumbles.

Award of easily gained yardage.

Penalties for unsporting behavior.

### Operation of Invention

The invention consists of a flat “field.” Players shall take cards from the piles and move the sports marker device depending on the quality of the answer and the actions indicated on the card. Various embodiments of the game are envisaged, where the time may be measured for each player, or a fixed-point score determines winning.

### Description and Operation of Alternative Embodiments

The drawings represent an embodiment of the device. The scope of the device is however limited only by the scope of the claims and not by a particular embodiment shown in the drawings. Among the various embodiments are included varying physical embodiments of the game such as a board game, a computer version, a hand-held electronic device and even the use of Internet-based pairing or team formation. Also envisaged are various color code or labeling embodiments for the board and for the pieces. It is also envisaged that the same principles can be applied to a number of other sporting activities, including, but not limited to, soccer, basketball, volleyball, baseball, etc.

### Conclusion, Ramification & Scope of Invention

Although the description above contains much specificity, these should not be construed as limiting the scope of the invention but as merely illustrations of some of the presently preferred embodiments of this invention. Thus, the scope of the invention should be determined by the appended claims and their legal equivalents, rather than by the examples given.

I claim:

1. A trivia sports game comprised of:
A background or field of play that resembles a certain sport's field;
A deck of trivia cards each asking a different question related to the theme sport and providing the correct answer to said question;
Cards marked for special moves in the game;
A sports piece.

2. The trivia sports game described in claim 1 wherein the such game is embodied as a computer game.

3. The trivia sports game described in claim 1 wherein such game is embodied in an electronic hand-held version.

4. The trivia sports game described in claim 1 wherein such game is provided online on the Internet.

5. The trivia sports game described in claim 1 wherein the theme is football.

6. The trivia sports game described in claim 1 wherein the theme is basketball.

7. The trivia sports game described in claim 1 wherein the theme is baseball.

8. The trivia sports game described in claim 1 wherein the theme is soccer.

9. The trivia sports game described in claim 1 wherein the theme is volleyball.

10. The trivia sports game described in claim 1 wherein the trivia cards ask questions regarding the theme sport, including but not limited to history, factoids, players, teams, team owners, coaches, statistic result data, fans, etc.

11. The trivia sports game described in claim 1 wherein the questions are in a multiple choice question format.

12. The trivia sports game described in claim 1 wherein the questions are in a True or False question format.

13. The trivia sports game described in claim 1 wherein the questions are in a simple answer format.

14. The trivia sports game described in claim 1 wherein the questions are in a combination of multiple choice, True or False or simple answer question format.

15. The trivia sports game described in claim 1 wherein the cards marked for special moves in the game are “Wild Cards.”

16. The trivia sports game described in claim 1 wherein the cards marked for special moves in the game are “Down Cards.”

17. The trivia sports game described in claim 1 wherein the cards marked for special moves in the game are “Kick Off Cards.”

18. The trivia sports game described in claim 1 wherein the cards marked for special moves in the game are “Extra Points.”

19. The trivia sports game described in claim 1 wherein the cards marked for special moves in the game are “Pass.”

20. The trivia sports game described in claim 1 wherein the cards marked for special moves in the game are “Punt.”

21. The trivia sports game described in claim 1 wherein the cards marked for special moves in the game include but are not limited to “Wild Card,” “Down Card,” “Kick Off,” “Extra Points,” “Pass” and “Punt.”

22. The trivia sports game described in claim 1 wherein the duration of the game is a finite time period for each player.

23. The trivia sports game described in claim 1 wherein the duration of the game is based on a fixed-point score winner basis.
